(19) United States
(12) Patent Application Publication
(10) Pub. No.: US 2026/0348414 A1
(43) Pub. Date: Nov. 5, 2026

(54) COUPLING ASSEMBLY FOR A MANIKIN

(71) Applicant: North American Rescue, LLC, Greer, SC (US)

(72) Inventors: Christopher Michael Kuharik, Frankfort, KY (US); Ian Thorn Miller, Goshen, KY (US); Keary Miller, Eastpoint, FL (US); Benjamin Scott Clift, Louisville, KY (US); Eli Beck Heintzman, Louisville, KY (US)

(21) Appl. No.: 19/198,699

(22) Filed: May 5, 2025

(51) Int. Cl. F16B 7/10

(52) U.S. Cl. CPC F16B 7/10

(57) ABSTRACT

A coupling assembly for a manikin is disclosed. The coupling assembly includes a female coupling assembly embedded within a first portion of a manikin, the female coupling assembly includes: a housing; a first hydraulic hose mechanically attached to the housing; a clamp mechanically attached to the housing, wherein the clamp comprises a protruding arm; and a first fluid coupling in fluidic communication with the first hydraulic hose. The coupling assembly includes a male coupling assembly at least partially embedded within a second portion of the manikin, the male coupling assembly includes: a coupling interface; a second hydraulic hose mechanically attached to the coupling interface; and a second fluid coupling in fluidic communication with the second hydraulic hose to mate with the first fluid coupling; and a mating connection between the male coupling assembly and the female coupling assembly.

### FIELD

The present disclosure relates generally to a coupling assembly for a manikin.

### BACKGROUND

Manikins are widely used to replicate real-life medical scenarios. These manikins may rely on modular components that can be swapped or reconfigured to simulate different types of injuries or treatment scenarios. However, conventional modular manikins often suffer from difficulty removing and replacing the limbs of the manikin. Existing coupling mechanisms used to attach or detach limbs and injury modules may require specialized tools, involve complex alignment procedures, or fail to maintain consistent fluidic or electrical connections during repeated use.

Accordingly, improved coupling systems are desired in art. In particular, coupling systems which allow limbs to be swapped out with ease would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a coupling assembly for a manikin is provided. The coupling assembly includes a female coupling assembly embedded within a first portion of a manikin, the female coupling assembly comprising: a housing; a first hydraulic hose mechanically attached to the housing; a clamp mechanically attached to the housing, wherein the clamp comprises a protruding arm; and a first fluid coupling in fluidic communication with the first hydraulic hose. The coupling assembly includes a male coupling assembly at least partially embedded within a second portion of the manikin, the male coupling assembly comprising: a coupling interface; a second hydraulic hose mechanically attached to the coupling interface; and a second fluid coupling in fluidic communication with the second hydraulic hose to mate with the first fluid coupling. The coupling assembly includes a mating connection between the male coupling assembly and the female coupling assembly.

In accordance with another embodiment, a coupling assembly for a manikin is provided. The coupling assembly includes a female coupling assembly embedded within a first portion of a manikin, the female coupling assembly comprising: a housing; a first hydraulic hose mechanically attached to the housing; a clamp mechanically attached to the housing, wherein the clamp comprises a protruding arm; and a first fluid coupling in fluidic communication with the first hydraulic hose. The coupling assembly includes a male coupling assembly at least partially embedded within a second portion of the manikin, wherein the second portion of the manikin comprises an artificial injury, the male coupling assembly includes: a coupling interface; a second hydraulic hose mechanically attached to the coupling interface, wherein the second hydraulic hose is in fluidic communication with the artificial injury; and a second fluid coupling in fluidic communication with the second hydraulic hose to mate with the first fluid coupling. The coupling assembly includes a mating connection between the male coupling assembly and the female coupling assembly.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIGS. 1A-B are exemplary embodiments of two or more coupling assemblies embedded within a manikin in accordance with embodiments of the present disclosure;

FIGS. 2A-G are exemplary embodiments of the female coupling assembly in accordance with embodiments of the present disclosure;

FIGS. 3A-B are exemplary embodiments of the male coupling assembly in accordance with embodiments of the present disclosure;

FIGS. 4A-B are a cross-sectional view of the mating connection between the female coupling assembly and the male coupling assembly in accordance with embodiments of the present disclosure; and

FIG. 5 is an exploded view of the female coupling assembly and the male coupling assembly for a manikin in accordance with embodiments of the present disclosure.

Reference numerals that are repeated across plural figures are intended to identify the same features in various implementations.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, a coupling assembly for a manikin is disclosed. The assembly may include a female coupling assembly embedded within the first portion of the manikin. This female coupling assembly may include a housing that functions as a structural casing and interface point for various components. Mechanically secured to the housing is a first hydraulic hose, which is responsible for transporting fluid to a synthetic injury of the manikin. Also attached to the housing is a clamp configured to control the flow of fluid through the first hydraulic hose. The clamp features a protruding arm that allows external pressure, such as from a tourniquet, to mechanically close off the hose and stop fluid flow. A first fluid coupling is fluidically connected to the first hydraulic hose, allowing for controlled transfer of fluids when engaged.

The male coupling assembly may be wholly or partially embedded within a second portion of the manikin. The male coupling assembly may include a coupling interface that is configured to fit within the female coupling assembly. Attached to the coupling interface is a second hydraulic hose that mirrors the functionality of the first hydraulic hose. This second hydraulic hose may be in fluidic communication with a second fluid coupling, which is positioned to mate with the first fluid coupling of the female assembly. When properly connected, the fluid couplings form a continuous, sealed path for fluids to move between the manikin components. The male coupling assembly may be designed to be guided into position by the housing of the female coupling assembly.

The connection between the male and female coupling assemblies may be referred to as a mating connection. This mating connection may allow the coupling interface to engage with internal locking features of the housing.

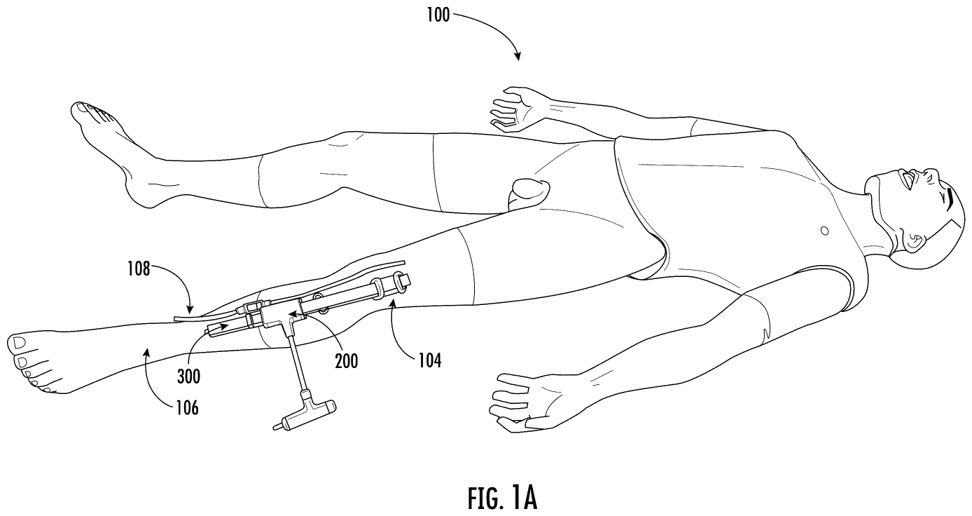

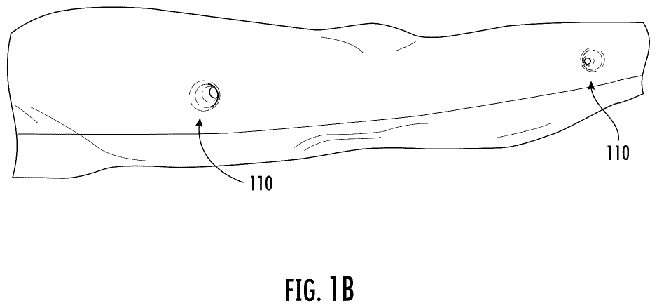

Referring now to FIGS. 1A-B, an exemplary embodiment of two or more coupling assembly embedded within a manikin in accordance with embodiments of the present disclosure.

FIG. 1 depicts a manikin 100. As used in the current disclosure, manikin 100 is a life-sized, human-shaped model designed to replicate the anatomy, physiology a real person. The manikin 100 may be a tool for medical training, providing students, healthcare professionals, and emergency responders with a realistic platform to practice a wide range of medical procedures. These procedures may include trauma care, wound treatment, first-aid techniques, surgical techniques, life-saving interventions, and the like.

In an embodiment, the manikin 100 may be constructed from silicone or similar substances to closely mimic the texture, flexibility, and resilience of human skin and soft tissues. The use of silicone may allow for a more lifelike tactile experience. In some cases, the manikin 100 may include internal structures, such as simulated bones, muscles, organs, and the like.

The manikin 100 may include a first portion 104. The first portion 104 of the manikin 100 may include structural elements to which other components can be attached, such as the female coupling assembly 200. The first portion 104 may include the torso of the manikin 100. In embodiments where the first portion 104 includes the torso, limbs and other extremities may be attached to the torso using assemblies 200 and 300. The first portion 104 may also include portions of limbs, such as the brachial region, forearm, femoral region, crural region, and the like. The female coupling assembly 200 may be embedded within the first portion 104 of the manikin 100. This may serve as a secure attachment point for the second portion 106 of the manikin 100. The female coupling assembly 200 is discussed in greater detail herein below.

The manikin 100 may include a second portion 106. The second portion 106 of the manikin 100 may consist of all or portions of limbs or other extremities. The second portion 106 of the manikin 100 may be designed to be attached to the first portion 104 using assemblies 200 and 300, respectively. Exemplary second portions 106 of the manikin 100 may include all or portions of limbs, such as the brachial region, forearm, femoral region, crural region, and the like.

FIG. 1A depicts the male and female coupling assemblies 200 and 300 embedded within the first portion 104 and the second portion 106 of the manikin 100, respectively. In this embodiment, the female coupling assembly 200 is positioned within the first portion 104 of the manikin, while the male coupling assembly 300 is integrated into the second portion 106.

In an embodiment, the first portion 104 or the second portion 106 of the manikin 100 may incorporate an artificial injury 108. The artificial injury 108 can replicate a variety of wounds that necessitate the use of a tourniquet. The artificial injury 108 may include synthetic gunshot wounds, stab wounds, puncture wounds, or other forms of deep tissue trauma that result in severe bleeding from an extremity. These synthetic injuries 108 may be designed to provide a lifelike appearance and texture, mimicking real human tissue and wound characteristics.

The manikin 100 may include integrated fluid systems associated with the synthetic injuries 108 that simulate active bleeding. These systems may use tubing and pressurized reservoirs to create a continuous or pulsing blood flow, requiring trainees to apply appropriate techniques such as direct pressure, wound packing, or tourniquet placement to control hemorrhaging. The fluid may be colored and thickened to resemble real blood, further immersing trainees in the simulation.

With continued reference to FIG. 1B, the manikin 100 may include a coupling point 110. As used in the current disclosure, the coupling point 110 refers to a designated structural interface located on the exterior of the manikin 100 that provides access to the locking assembly 214. This interface may be positioned to allow users to interact with the internal components of the manikin, specifically the locking mechanism that secures the male coupling assembly 300 within the female coupling assembly 200.

The coupling point 110 may take the form of an aperture, panel, or recessed opening located on the surface of the manikin 100. Through this coupling point 110, users can engage or disengage the locking assembly 214 using tools or manual actuators, such as a decoupler.

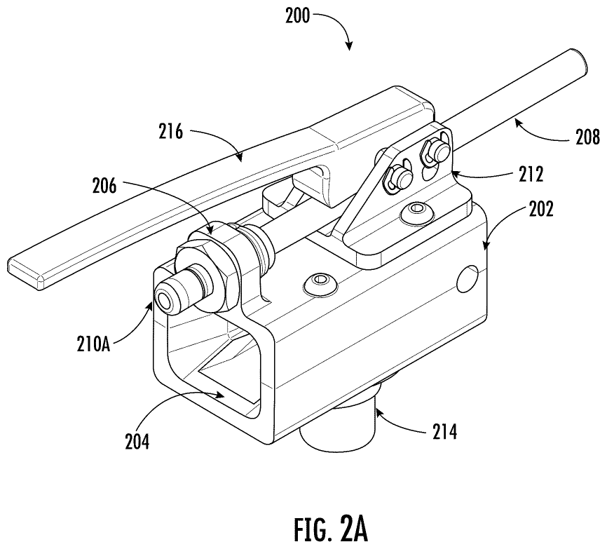

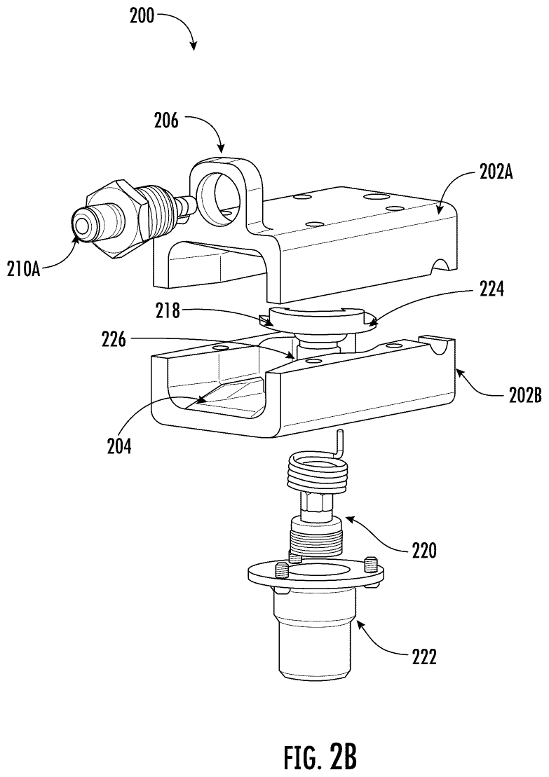

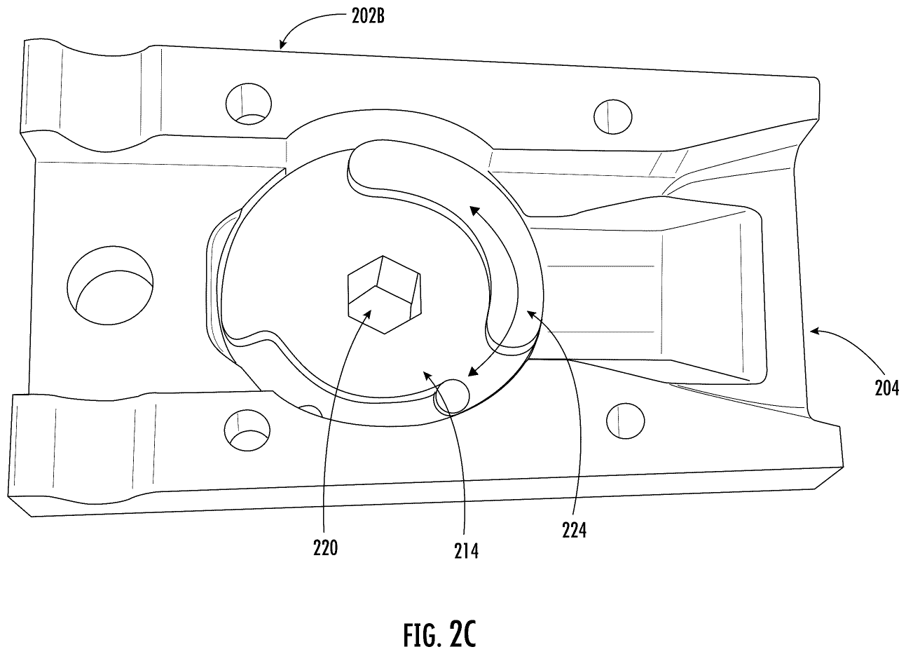

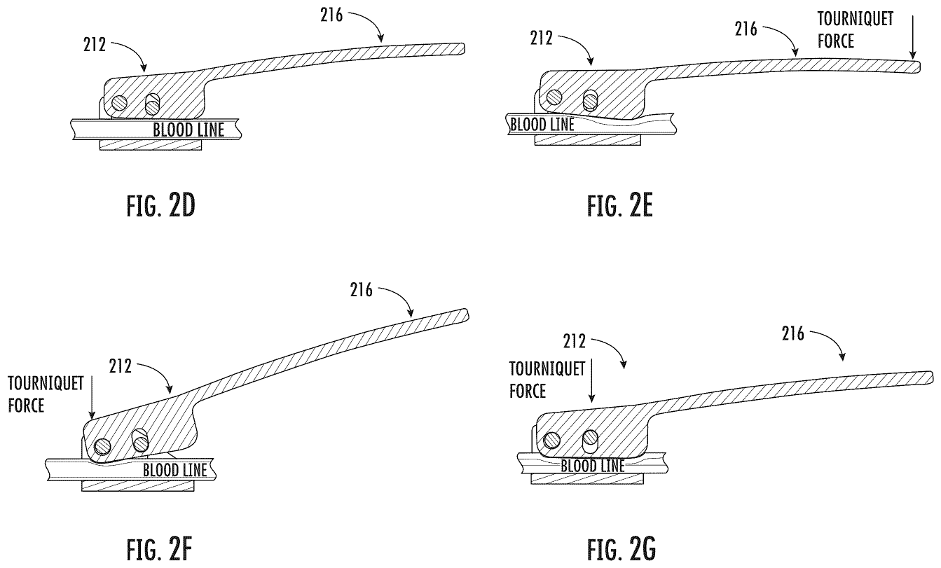

Referring now to FIGS. 2A-G, exemplary embodiments of the female coupling assembly 200 in accordance with embodiments of the present disclosure.

As used in the current disclosure, the female coupling assembly 200 is a structural component designed to facilitate the secure and functional attachment of all or portions limbs of a manikin (e.g., manikin 100—FIG. 1A). The female coupling assembly 200 may serve as a receptacle for a corresponding male coupling assembly 300. The design of the female coupling assembly 200 may facilitate the selective attachment of the limbs of the manikin 100.

The female coupling assembly 200 may be positioned within the manikin 100 to enable the attachment of limbs at anatomically appropriate locations. This includes placement near the hip joints or shoulder joints to allow for the connection of the manikin's legs or arms, respectively. In some embodiments, the female coupling assembly 200 may also be positioned within specific regions of a limb, such as the brachial region, forearm, femoral region, or crural region, to support the attachment of adjacent limb segments. Additionally, the assembly may be located near joint areas, such as the elbow or knee, to facilitate the secure connection of forearms or lower legs.

The female coupling assembly 200 includes a housing 202. The housing 202 may take various shapes, including a rectangular prism, cube, cylinder, rectangular prism, trapezoidal prism, trapezoidal cuboid, and the like. In an embodiment, the interior of the housing 202 may include a geometry that is similar to that of the male coupling assembly 300. The interior of the housing 202 may include a geometry that generally mirrors or complements the external shape of the male coupling assembly 300.

In an embodiment, the cavity of the housing 202 may be generally defined by a partially enclosed space that is shaped to receive the male coupling assembly 300. The cavity may include a primary section extending longitudinally through the housing 202, this cavity is designed to closely match the outer surface of the coupling interface 302. This may mean that the interior of the housing includes geometry that is similar to a rectangular prism, cube, cylinder, trapezoidal prism, trapezoidal cuboid, and the like. The interior cavity of the housing 202 may have slightly larger measurements than the coupling interface 302 to allow for insertion.

The interior of the housing 202 is configured to receive the male coupling assembly 300, facilitating a mating connection 400. Additionally, the housing structure may be designed to support the mechanical attachment of locking mechanisms 214, hydraulic components, electrical components, and other mechanical components of assembly 200.

The housing 202 may be constructed in two or more sections, such as a first portion 202A and a second portion 202B. The two or more sections may work in tandem to enclose at least a portion (e.g., the internal mechanisms) of the female coupling assembly 200. In some embodiments, the first portion 202A forms the bottom portion of the housing 202, while the second portion 202B forms the top portion. Alternatively or additionally, the first portion 202A may be associated with the exterior of the housing while the second portion 202B may be associated with the interior of the housing. These two sections may be securely joined together using a plurality of screws and corresponding apertures.

In an embodiment, the first portion 202A of the housing 202 may include a ramp 204 designed to guide the male coupling assembly 300 into position. The ramp 204 may facilitate the alignment between the male coupling assembly 300, female coupling assembly 200, and the locking assembly 214. The ramp 204 may include a gradual incline to aid in the insertion process of the male coupling assembly 300.

In an embodiment, the ramp 204 may be positioned along the interior bottom surface of the housing 202. The ramp 204 may be oriented at an upward angle extending from the opening of the cavity toward the rear of the housing. The ramp 204 may begin at a lower elevation adjacent to the cavity opening and rise gradually toward the aperture associated with the locking assembly 214. The surface of the ramp 204 may be smooth and continuous, providing a guided pathway for the protruded region 306 of the male coupling assembly 300 as it is inserted into the housing. In some embodiments, the ramp 204 may also include lateral guide features, such as shallow sidewalls or channels along its edges, to assist with centering and stabilizing the male coupling interface during insertion. The top end of the ramp 204 may terminate near the region where the cam head 224 engages with the cam interface 304.

The housing 202 may also include a protruded attachment point 206. The protruded attachment point 206 may be used to accommodate the first hydraulic hose 208 and the first fluid coupling 210A. This protruded attachment point 206 may allow a portion of the hydraulic hose 208 to be attached to the first fluid coupling 210A, facilitating fluid communication between connected components.

Additionally, the housing 202 may define a plurality of apertures on both the top and bottom surfaces of the housing 202. These apertures may be positioned to accommodate or receive the mechanical attachment of various components, such as the clamp 212, locking assembly 214, or the fasteners (e.g., bolts?) that connect the first portion 202A to the second portion 202B.

In one embodiment, the housing 202 of the female coupling assembly 200 is defined by a number of distinct sides: a first side, a second side, a third side, and a fourth side. The first side of the housing may include the protruded attachment point 206 and the clamp 212. The second side of the housing may be positioned opposite the first side and may function as the primary access interface for the locking assembly 214. This second side may defined an aperture, specifically designed (e.g., sized and shaped) to receive the locking assembly 214. Within the interior of the second side of the housing, a ramp 204 may be integrated to guide the insertion of the male coupling assembly 300 into the mating position 402. This ramp 204 may be angled or curved to align a coupling interface 302 precisely with a cam interface (e.g., described below) or other internal components.

With continued reference to FIGS. 2A-G, the female coupling assembly 200 may include one or more hydraulic hoses 208. The hydraulic hoses 208 may be designed to facilitate the fluidic connection between the manikin's synthetic injuries 108 and the various systems that simulate active bleeding. These hoses function as the primary channels for the flow of fluid through the manikin 100. The hydraulic hoses 208 may be designed to operate within the manikin's 100 fluidic network, carrying simulated blood or other fluids from a fluid reservoir or pump system to the synthetic injuries 108. The first hydraulic hose 208 and the second hydraulic hose may be mechanically linked to the first and second fluid couplings 210A-B, respectively.

The first hydraulic hose 208 may be attached to the first fluid coupling 210A. The first hydraulic hose 208 and the first fluid coupling 210A may be positioned to be fluidically connected to the second fluid coupling 210B when a mating connection 400 is formed between the female coupling assembly 200 and the male coupling assembly 300. The first fluid coupling 210A serves as the point of fluidic communication between the first hydraulic hose 208 and the fluid system within the manikin.

The second fluid coupling 210B may be connected to the second hydraulic hose. Once the fluid is directed through the first hydraulic hose 208 and the first fluid coupling 210A, it may pass through the second fluid coupling 210B and the second hydraulic hose to into the artificial injury 108. The second hydraulic hose and second fluid coupling 210B may be attached to the male coupling assembly 300, allowing the female coupling assembly 200 to interface with the synthetic limbs or extremities of the manikin 100.

The first hydraulic hose 208 and first fluid coupling 210A may be mechanically attached to the protruded attachment point 206 of the housing 202. This attachment point may provide an interface for the fluidic connection between the male coupling assembly 300 and the female coupling assembly 200. The protruded attachment point 206 may be used to align the first fluid coupling 210A to another fluid coupling.

In an embodiment, the protruded attachment point 206 of the housing 202 may be positioned on a first side of the housing 202, while the protruded attachment point 308 of the coupling interface 302 may be located on a corresponding side of the coupling interface 302. The orientation of these protruded attachment points may be configured such that they align once the male coupling assembly 300 reaches the mating position 402. During insertion, the relative positioning of the protruded attachment points 206 and 308 assists in guiding the alignment of the fluid couplings 210A and 210B. In the mating position 402, the protruded attachment points may press their respective fluid couplings together, thereby forming a fluidic connection between the male coupling assembly 300 and the female coupling assembly 200.

The first hydraulic hose 208 may be threaded through the protruded attachment point 206, while the first fluid coupling 210A is affixed to the protruded attachment point 206. The first fluid coupling 210A may be secured using fasteners (e.g., screws, bolts, rivets, or threaded inserts). When assembled, the fasteners may hold both the hose and the first fluid coupling 210A in place, preventing any shifting or disconnections.

The hydraulic hoses 208 and fluid couplings 210 may work together to create a fluidic network within the manikin, mimicking the physiological responses of the human body to injuries. The first hydraulic hose 208 and second hydraulic hose carry the simulated fluid from the reservoir or pump system to the synthetic injuries 108, where it is released in a controlled manner to simulate active bleeding. This may allow users to practice critical medical procedures, such as the application of a tourniquet, in a realistic setting that mimics actual life-threatening conditions.

With continued reference to FIG. 2A-G, the female coupling assembly 200 includes a clamp 212 mechanically attached to the housing 202, wherein the clamp 212 comprises a protruding arm 216. As used in the current disclosure, the clamp 212 is a structural component designed to regulate the flow of fluid through the first hydraulic hose 208A. The clamp 212 may function as a selective flow restriction mechanism, ensuring that fluid movement can be halted when desired. The first hydraulic hose 208 may be routed beneath the clamp 212, allowing the clamp to selectively apply mechanical pressure and create a pinch point that stops the fluid's passage. This mechanism simulates medical interventions such as the application of a tourniquet or other first-aid techniques used to control bleeding.

The clamp 212 is mechanically attached to the housing 202 through a series of fasteners and apertures within the housing 202. The housing 202 may include predefined apertures designed to accommodate screws, bolts, or other mechanical fasteners, allowing the clamp 212 to be firmly affixed in place. These mounting points may be strategically positioned to ensure that the clamp 212 aligns properly with the first hydraulic hose 208A, allowing the hose 208 to pass directly beneath the one or more pinch points of the clamp. Advantageously, the clamp 212 (or other features disclosed herein) may ensure that when pressure is applied, the clamp 212 can effectively constrict the flow of fluid through the hose, simulating the effect of tourniquet application or direct pressure.

The clamp 212 may operate by exerting downward force onto the first hydraulic hose 208A, effectively pinching it shut at one or more pinch points. The clamp 212 (or other features disclosed herein) may notably allow for precise pressure application, enabling it to respond to external forces such as the manual application of a tourniquet or direct pressure to the injury site. This provides a realistic simulation of how fluid flow in a bleeding limb can be restricted through standard medical procedures. In turn, when a first-aid technique is applied, the simulated bleeding responds accordingly by stopping or slowing the flow of fluid.

In an embodiment, the clamp 212 includes a protruded arm 216. The protruded arm 216 may extend outward from the clamp 212 to serve as a lever mechanism. The protruded arm 216 may be attached to the clamp 212 at one or more pivot points, allowing it to function as an additional control mechanism for stopping fluid flow. When pressure is applied to the protruded arm 216, it may transfer force to the clamp's 212 movement points, causing the first hydraulic hose 208 to be constricted and effectively blocking the fluid flow. This lever-like functionality may be used to extend the area to which pressure can be applied to the limb to restrict the flow of fluid.

The clamp 212 may include two or more movement points, one at the front of the clamp and one at the back. These movement points may allow the clamp 212 to adjust based on the force applied. When direct pressure is exerted onto the clamp 212 itself, both movement points are forced downward simultaneously, tightening the clamp's grip on the first hydraulic hose 208 and creating a pinch point. Alternatively, when pressure is applied specifically to the protruded arm 216, only one of the movement points may be pushed down. The movement point closest to the attachment point of the protruded arm 216 may be compressed to enable a gradual constriction of fluid flow. These movement points enable the clamp 212 to move in such a way that, when force is applied to the clamp by a tourniquet at any location, the flow of fluid is constricted.

In an embodiment, the two movement points of the clamp 212 collectively function as a hinge, allowing the clamp to pivot or rock forward when force is applied to the protruding arm. These movement points may enable the clamp to articulate in a controlled and directional manner, such that the underside of the clamp presses against the hydraulic hose to form a pinch point, thereby regulating or restricting fluid flow. One of the movement points may be configured to allow vertical displacement of a portion of the clamp, enabling one end to lower while the opposite end lifts.

In an embodiment, the clamp 212 is provided as a spring-loaded clamp, maintaining an open position by default. An internal spring mechanism may force the clamp to remain open, allowing fluid to move freely through the first hydraulic hose 208 under normal conditions. When an external force is introduced, the clamp 212 may be forced into a closed position, thereby restricting or reducing the flow of fluid. One or both of the movement points within the clamp 212 may also be spring-loaded, adding an additional layer of mechanical responsiveness.

With continued refence to FIG. 2, the female coupling assembly 200 may include a locking assembly 214. The locking assembly 214 may include a cam 218, a decoupler 220, a shroud 222, a head 224, and the like. Separately or together, the components of the locking assembly 214 may contribute to the secure engagement and controlled release of the male coupling assembly 300 with the female coupling assembly 200.

Generally, the head 224 of the cam 218 may selectively mate with a cam interface 304 located on the coupling interface 302. As used in the current disclosure, the cam 218 includes or is provided as a mechanical locking component within the locking assembly 214. In turn, the cam 218 may secure the male coupling assembly 300 when it is inserted into the female coupling assembly 200. This securing action may be achieved by the head 224 of the cam 218 engaging with the cam interface 304 of the male coupling interface 302. The coupling assemblies may be coupled through a combination of mechanical interlocking and spring-loaded tension. The cam 218 operates by engaging with the cam interface 304 on the coupling interface 302. When the cam 218 engages with the cam interface 304, a mating connection 400 may be established between the male coupling assembly 300, the female coupling assembly 200, and the locking assembly 214.

In one embodiment, the cam 218 is spring-loaded. For instance, the cam 218 may automatically lock into place when the male coupling assembly 300 reaches the mating position. The spring-loaded cam 218 may be configured to apply constant pressure to the cam interface 304, preventing the male coupling assembly 300 from becoming dislodged during movement or applied forces. This automatic locking mechanism is enabled by the spring's tension, which ensures the cam head 224 securely engages with the cam interface 304 once the male coupling assembly reaches its proper position. To detach the male coupling assembly 300, the decoupler 220 is engaged, releasing the cam 218 from the cam interface 304 and allowing the coupling interface 302 to be withdrawn from the female coupling assembly 200.

The spring-loaded cam 218 may include structural elements designed to provide automatic locking functionality. The cam 218 itself may include a cylindrical or contoured body that is inserted into the housing 202 of the female coupling assembly 200. The body of the cam has a head 224 at one end, which is designed to interact with the cam interface 304 of the male coupling assembly 300 when properly aligned.

The spring-loaded mechanism may be integrated within the cam's body. This may take the form of a coil spring or compression spring that is positioned around the cam's shaft or embedded within the housing. The spring provides the necessary tension to push the cam head into the locked position when the male coupling assembly 300 reaches the mating position 402. The spring may be calibrated to apply a constant force, keeping the cam head engaged with the cam interface and preventing accidental disconnection.

A secondary feature of the spring-loaded cam may be its ability to retract when the decoupler 220 is activated. When the decoupler 220 disengages the spring's tension, it may allow the cam to move away from the cam interface and freeing the male coupling assembly for removal.

The cam 218 may include a head 224. The head 224 of the cam 218 may be a structural component facilitating the engagement and locking mechanism of the cam 218 within the locking assembly 214. For instance, the head 224 may be a primary contact point between the cam 218 and the cam interface 304 of the male coupling assembly 300. The head 224 may be shaped (e.g., as a complementary structure) to effectively latch onto, grip, slide into, rotate into, or otherwise engage the corresponding cam interface 304. The head 224 may be designed in various geometric configurations, such as rounded, angled, hook-shaped, or wedge-like.

The cam 218 may include a shaft 226 that extends from the decoupler 220 through the shroud 222, forming a structural link between the locking and release mechanisms of the assembly. This shaft 226 may serve as or define the central axis around which the cam 218 pivots or slides when engaged or disengaged.

In an embodiment, the locking assembly 214 includes a decoupler 220. As used in the current disclosure, the decoupler 220 is a mechanical release mechanism to selectively disengage the cam 218. The decoupler 220 may allow for the controlled detachment of the male coupling assembly 300 from the female coupling assembly 200. The decoupler 220 may include a sliding or rotating element that, when activated, moves in such a way that it applies force to the cam 218. This force may be configured to release the spring tension that holds the cam head 224 in the locked position. The triggering mechanism could be in the form of a button, lever, or pull mechanism, designed to be operated manually or automatically. The decoupler 220 may function by applying force to the shaft 226, which in turn shifts the cam 218 out of engagement with the cam interface 304, effectively unlocking the mating connection 400. The decoupler 220 may be manually or automatically activated, depending on the specific design of the system. A user may press, pull, or rotate a release lever or button to disengage the cam.

The decoupler 220 may include a keyed mechanism that is mechanically affixed to the cam 218, allowing for controlled engagement and disengagement of the locking assembly 214. This keyed mechanism may interact with the internal components of the cam 218, enabling the user to manually control the locking and unlocking process. The keyed feature, such as a pin or slot, is securely attached to the cam and designed to accept an external key. A user can insert a key, such as a hex key, Allen key, or similar tool, into the keyed mechanism and rotate it to disengage the cam from its locked position within the cam interface.

The key mechanism allows the user to engage or disengage the cam 218 by manually turning the key, which applies rotational force to the internal components of the decoupler. When the key is turned, it releases the spring tension on the cam, effectively unlocking the cam from its engaged position. This action facilitates the separation of the male coupling assembly 300 from the female coupling assembly 200.

In an embodiment, the decoupler 220 may be partially embedded within the manikin 100 near the coupling point 110. This embedded configuration allows the decoupler 220 to be strategically positioned near thigh, arm, leg, forearm, shoulder, hip, elbow, knee joints, and the like of the manikin 100.

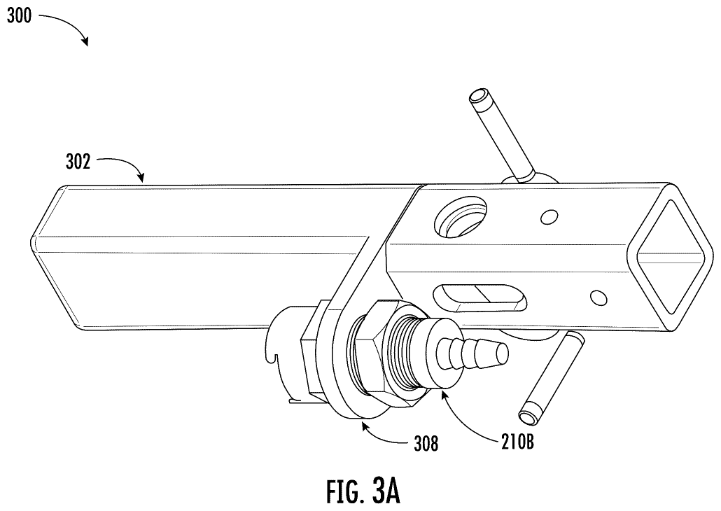

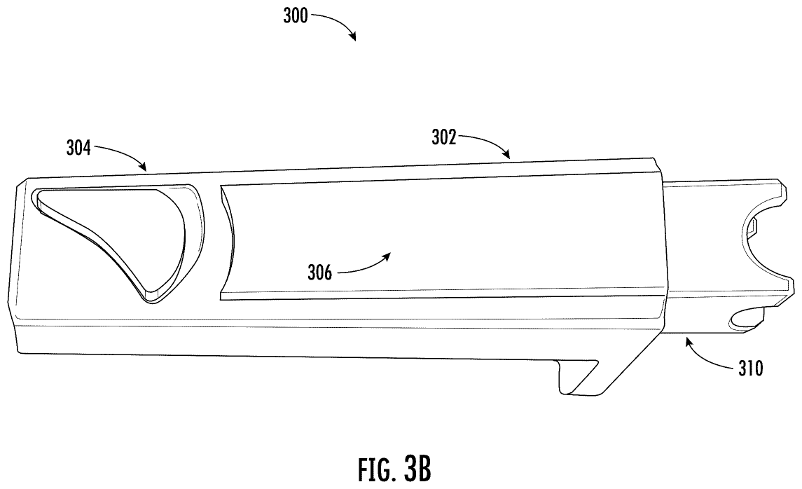

Referring now to FIGS. 3A-B, an exemplary embodiment of the male coupling assembly 300 in accordance with embodiments of the present disclosure.

The male coupling assembly 300 may be designed to be partially inserted into the female coupling assembly 200 to establish a secure, detachable connection between different portions of the manikin 100. The male coupling assembly 300 may be used to quickly attach, remove, and/or replace limbs or extremities of the manikin 100. The structural configuration of the male coupling assembly 300 allows it to be integrated with the female coupling assembly 200, forming a mating connection 400 when properly inserted.

The male coupling assembly 300 may include a coupling interface 302. As used in the current disclosure, the coupling interface 302 refers to a rigid shell defining a mechanical interface between the male and female coupling assemblies 300 and 200. The coupling interface 302 may take various shapes, including a cylinder, cone, rectangular prism, trapezoidal prism, trapezoidal cuboid, and the like. The coupling interface 302 may have a tapered shape, with the end intended for insertion into the female coupling assembly 200 being narrower than the opposite end. The coupling interface 302 may be shaped to facilitate the attachment, removal, and replacement of limbs or extremities of the manikin 100. A portion of the coupling interface 302 may be partially inserted into the female coupling assembly 200, while the remaining portions are embedded within the second portion 106 of the manikin 100.

In an embodiment, the coupling interface 302 may include a cam interface 304. As used in the current disclosure, the cam interface 304 is a structural feature located on the coupling interface 302, specifically designed to receive and interact with the cam 218 of the locking assembly 214. It may take the form of a groove, indentation, or raised surface that allows the cam 218 to latch securely when the male coupling assembly 300 is fully inserted. The cam interface 304 may be positioned to ensure that the locking assembly 214 engages at the correct angle, maximizing stability and load distribution.

In one embodiment, the cam interface 304 may be a rounded or curved opening integrated into the surface of the coupling interface 302. This rounded profile may be configured to allow the head 224 of the cam 218 to rotate into a locking position once the coupling interface 302 reaches the fully seated or mating position. The rounded geometry of the cam interface 304 may be used to guide the head 224 of the cam into alignment. The curvature of the opening allows rotational engagement, which further enhances the mechanical grip between the male and female coupling assemblies.

The cam interface 304 may be formed by a series of protruded areas that extend from the body of the coupling interface 302. These protrusions may be spaced so that the negative space or gap between them defines the cam interface 304. When the male coupling assembly 300 is inserted into the female coupling assembly 200, the head 224 of the cam 218 enters this space and becomes lodged or locked into place behind the protruded areas. These protrusions act as mechanical stops, preventing the cam from backing out without deliberate disengagement via the decoupler.

In another embodiment, the cam interface 304 may be formed as a recessed area on the surface of the coupling interface 302. This recessed area may be designed to receive the head 224 of the cam 218 as it rotates into position, effectively trapping it within the depression to prevent disengagement. The recessed geometry may feature contoured sidewalls and a flat or curved base, allowing the cam head 224 to nest securely within the recessed area.

With continued reference to FIGS. 3A-B, the male coupling assembly 300 may include a protruded region 306. As used in the current disclosure, the protruded region 306 refers to a portion of the coupling interface 302 that extends outward along a specific path. The protruded region 306 may extend from the distal end of the male coupling interface 302 toward the cam interface 304. This region is complementary to and engages with internal guiding surfaces, such as the ramp 204 of the housing 202 within the female coupling assembly 200.

The protruded region 306 may be recessed or indented slightly inward from the outermost edge or perimeter of the male coupling interface 302. As the male coupling assembly 300 is inserted, this region interacts with the ramp 204 within the female coupling assembly 200. The protruded region 306 may serve as a track or rail to facilitate the mating between the male and female coupling assemblies 300 and 200.

In one embodiment, the protruded region 306 is tapered along its length, meaning that one end of the region extends taller from the surface of the male coupling interface 302 than the opposite end. This tapering may be gradual or stepped. The taller end of the tapered region may provide a greater vertical profile to initiate engagement with the guiding ramp of the female coupling assembly 200. As the male coupling interface 302 is advanced into the housing, the taper helps funnel and align the coupling interface 302 into the correct orientation. The shorter end of the protruded region 306 may be positioned near the cam interface 304 while the taller end of the protruded region 306 may be positioned near the opposite end of the male coupling interface 302.

Additionally, in some embodiments, the end of the protruded region 306 located near the cam interface 304 may be integrated into or form a portion of the cam interface 304 itself. In this configuration, the protruded region 306 not only guides the male coupling interface 302 into position but also contributes to the structural geometry that enables the cam 218 to engage and lock securely. For example, the edge of the protruded region 306 may blend into the cam interface 304, shaping part of the groove, recess, protrusion, or structural boundary that interacts with the head 224 of the cam.

With continued reference to FIG. 3, the male coupling assembly 300 may include a second protruded attachment point 308. As used in the current disclosure, the second protruded attachment point 308 supports or secures the second fluid coupling 210B. The second fluid coupling 210B facilitates fluidic communication with the first fluid coupling 210A, thereby enabling the passage of fluid between the first hydraulic hose 208 and the second hydraulic hose. The second protruded attachment point 308 may be located on an opposite side of the coupling interface 302 from the cam interface 304 and the protruded region 306.

The second protruded attachment point 308 may extend outward from the body of the male coupling interface 302 and is configured to accommodate the second fluid coupling 210B in a stable and secure position. Its structural design ensures that the second fluid coupling 210B remains properly aligned and does not shift during insertion or removal of the male coupling assembly 300. Additionally, the second protruded attachment point 308 may include a channel or aperture through which the second hydraulic hose is routed.

With continued reference to FIG. 3, the male coupling assembly 300 may include a coupling point 310. As used in the current disclosure, the coupling point 310 refers to a designated structural interface located on the male coupling assembly 300 that is configured to connect or attach the assembly to other internal components of the manikin 100. This coupling point 310 may be used to attach the male coupling assembly 300 to the manikin 100. The coupling point 310 may be designed to interface with internal structural members, such as support rods, brackets, or simulated skeletal elements that represent the bones of the manikin 100. These internal structures help replicate the rigidity of human anatomy.

Additionally, the coupling point 310 may include one or more features such as apertures, brackets, or threaded inserts to facilitate attachment. These features allow for screws, bolts, or other fastening elements to pass through and secure the coupling assembly to the structural framework of the manikin.

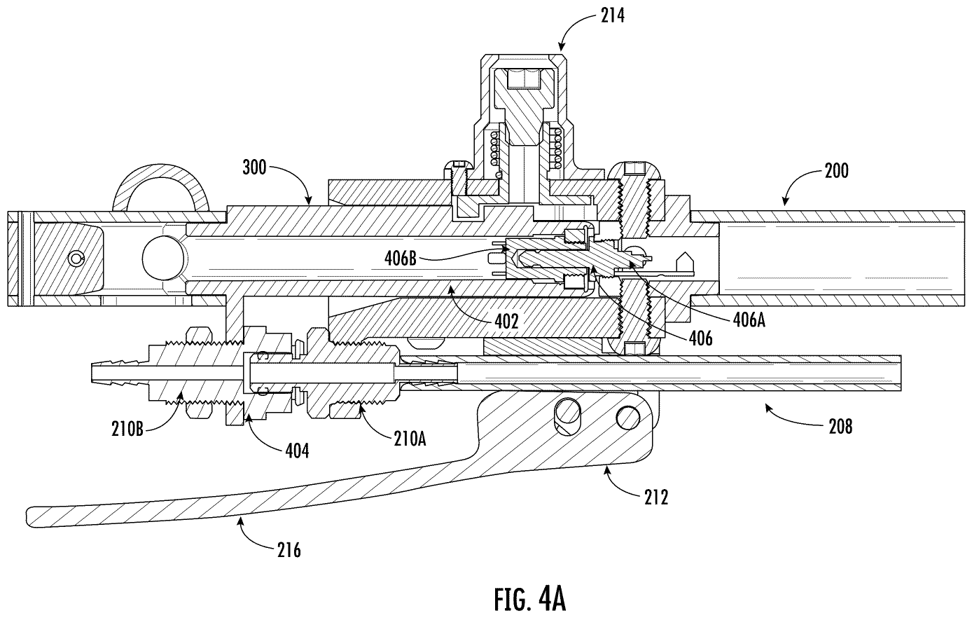

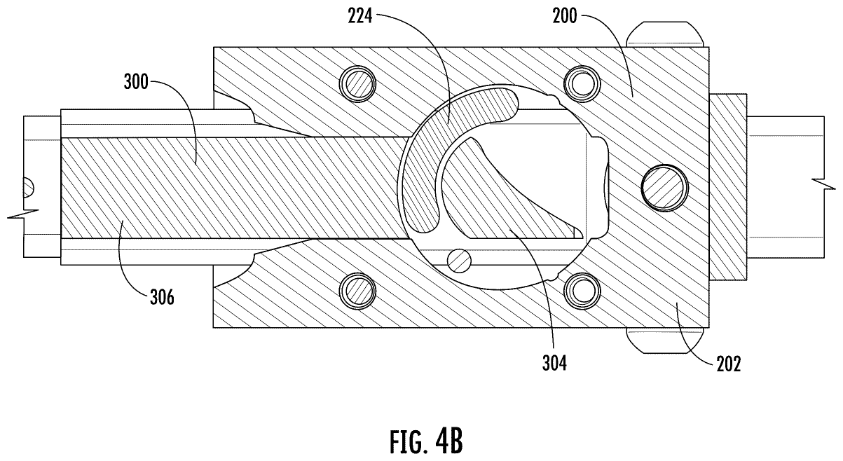

Referring now to FIGS. 4A-B, cross-sectional views of the mating connection 400 between the female coupling assembly and the male coupling assembly.

As used in the current disclosure, a mating connection 400 refers to the secure engagement between the locking assembly 214 of the female coupling assembly 200 and the cam interface 304 of the male coupling assembly 300. This connection functions as a mechanical interface that joins the two assemblies. When the mating connection 400 is established, it ensures that the male and female coupling assemblies 300 and 200 are locked in place.

The head 224 of the cam 218 may transition between three distinct positions during the mating sequence: a locked position, an unlocked position, and a storage position. In the locked position, the head 224 is securely engaged with the cam interface 304 on the coupling interface 302 of the male coupling assembly 300. This position is typically achieved after full insertion and alignment of the male coupling assembly 300 within the female housing 202.

In the unlocked position, the head 224 is retracted from the cam interface, allowing the male coupling assembly 300 to be freely removed from the female coupling assembly 200. This facilitates disassembly or reconfiguration of the manikin without excessive force or tools.

In the unlocked position, the head 224 of the cam 218 is retracted from the cam interface 304, allowing the male coupling assembly 300 to be freely removed from the female coupling assembly 200. The unlocked position of the head 224 may facilitate the disassembly or reconfiguration of the manikin 100. Transitioning the cam to the unlocked position is typically accomplished through the use of the decoupler 220, which is mechanically connected to the cam shaft 226 and accessible from the exterior of the manikin 100 through the coupling point 110.

In an embodiment, the decoupler 220 may be designed to facilitate the movement of the head 224 of the cam 218 between three distinct positions during the mating sequence. The decoupler 220 may include a keyed mechanism that is mechanically affixed to the cam 218. The keyed mechanism may be configured to engage with internal components of the cam 218, enabling the user to control the transition between these positions.

To move the cam head 224 to the unlocked position, the user may engage the decoupler 220 by inserting a key into the keyed mechanism. Upon rotation, the key disengages the cam from its locked position, allowing the head 224 to be retracted from the cam interface 304 and facilitating the removal of the male coupling assembly 300 from the female coupling assembly 200. Furthermore, the decoupler 220 may allow the head 224 of the cam 218 to transition to the storage position, where it is positioned temporarily out of the coupling path, ensuring that the male coupling assembly 300 can be freely inserted or removed without obstruction.

In the storage position, the head 224 of the cam 218 may be positioned at least partially in the path of insertion of the male coupling assembly 300. As the male coupling interface 302 is advanced into the housing 202 of the female coupling assembly 200, it comes into contact with the cam head 224, pushing it back momentarily. This interaction allows the male coupling assembly 300 to continue its insertion unobstructed. Once the coupling interface reaches the mating position 402 a spring-loaded mechanism within the cam 218 may cause the head 224 to automatically snap forward and engage with the cam interface 304.

Referring now to FIGS. 4A-B, a depiction of the male coupling assembly 300 in the mating position 402. As used in the current disclosure, the mating position 402 is defined as a spatial orientation and depth at which the male coupling assembly 300 is correctly aligned with the female coupling assembly 200. In this position, the cam interface 304 aligns with an aperture within the female housing 202, allowing the cam head 224 to extend into the cam interface 304 and secure the connection. The coupling interface 302 may be guided into position by the ramp 204 located within the housing 202.

With continued reference to FIG. 4, the mating connection 400 may include a fluidic connection 404 between the male coupling assembly 300 and the female coupling assembly 200 when the system reaches the mating position 402. This connection may involve the integration of the first fluid coupling 210A and the second fluid coupling 210B, which are respectively located at the first protruded attachment point 206 of the female coupling assembly 200 and the second protruded attachment point 308 of the male coupling assembly 300. When the coupling assemblies are joined, these fluid couplings are aligned and pressed together, creating a sealed interface that allows fluid to flow from the first hydraulic hose 208 through to the second hydraulic hose. These fluid couplings 210A-B may feature quick-connect mechanisms or pressure-sealing fittings to ensure secure engagement without the need for additional fasteners or manual tightening.

In some embodiments, the mating connection 400 may include an electrical connection 406 between the male coupling assembly 300 and female coupling assembly 200. Electrical components are configured to pass through the interior of the housing 202 and into the internal structure of the coupling interface 302. This setup enables power and signal transmission between embedded electronics within the manikin 100. In one embodiment, the male coupling assembly 300 may include a second electrical connector 406B located at the distal end of the coupling interface 302. This electrical connector may be aligned to mate with a first electrical connector 406A positioned within the interior cavity of the housing 202.

When the male and female coupling assemblies 406A-B are joined in the mating position 402, the electrical connectors 406A-B come into contact and form a closed circuit. These connectors may take the form of male and female pin-type connectors, magnetic snap connectors, or other low-profile interlocking mechanisms. The electrical connection 406 enables real-time communication and power delivery between the two assemblies, which may support sensors for pressure, fluid flow, temperature, or injury simulation status.

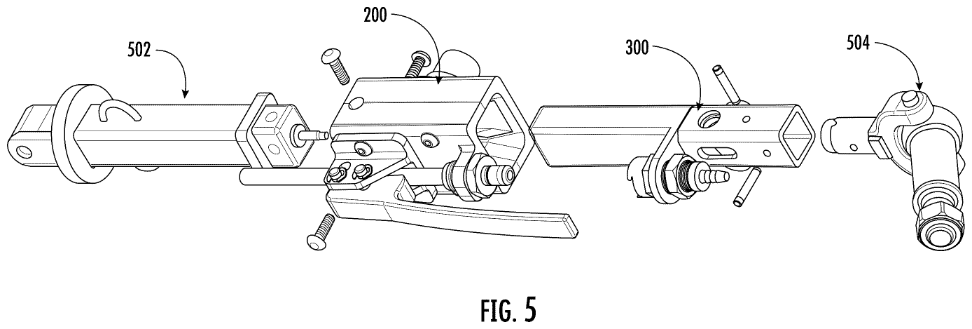

Referring now to FIG. 5, an exploded view is provided of the female coupling assembly 200 and the male coupling assembly 300 for a manikin, in accordance with embodiments of the present disclosure. FIG. 5 illustrates the interface between the male coupling assembly 300 and the female coupling assembly 200, along with the surrounding structural components 502 and 504 that integrate these assemblies into the overall framework of the manikin 100.

As used in the present disclosure, the structural components serve as a skeletal framework for the manikin. The structural components may be used to define the overall structure and simulate human anatomy within the manikin 100. The structural components may take the form of rigid frames, molded housings, or articulated supports that correspond to anatomical regions such as limbs or the torso. The structural components may be wholly or partly embedded into the first or second portion of the manikin.

These structural elements may be designed to both house and protect internal electrical and mechanical components. The structural components may include internal routing channels, compartments, or anchoring features for subcomponents such as hydraulic hoses, fluid couplings, wiring, and electrical connectors. In certain embodiments, these structural components may be modular or replaceable.

The structural components may include a first structural component (e.g., rigid scaffold) 502 and a second structural component (e.g., rigid scaffold) 504. The first structural component 502 may be attached to the female coupling assembly 200. It may be configured to secure the housing of the female coupling assembly 200 and may extend into or be embedded within a larger portion of the manikin, such as the torso or upper limb. This component may provide structural reinforcement and routing for the first hydraulic hose and any internal electrical elements.

The second structural component 504 may be attached to the male coupling assembly 300 and may be configured to support or house a portion of the second hydraulic hose as well as associated electrical connectors. In one embodiment, either or both of the structural components 502 and 504 may be configured to replicate anatomical joints (e.g. shoulder, elbow, or hip).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A coupling assembly for a manikin, the coupling assembly comprising:
a female coupling assembly embedded within a first portion of a manikin, the female coupling assembly comprising:
a housing;
a first hydraulic hose mechanically attached to the housing;
a clamp mechanically attached to the housing, wherein the clamp comprises a protruding arm; and
a first fluid coupling in fluidic communication with the first hydraulic hose; and
a male coupling assembly at least partially embedded within a second portion of the manikin, the male coupling assembly comprising:
a coupling interface;
a second hydraulic hose mechanically attached to the coupling interface; and
a second fluid coupling in fluidic communication with the second hydraulic hose to mate with the first fluid coupling; and
a mating connection between the male coupling assembly and the female coupling assembly.

2. The coupling assembly of claim 1, wherein the first hydraulic hose passes beneath the clamp in selective engagement therewith to selectively form one or more pinch points to restrict fluid flow through the hose.

3. The coupling assembly of claim 2, wherein the clamp comprises two or more spring loaded movement points.

4. The coupling assembly of claim 3, wherein the two or more spring loaded movement points mechanisms comprise at least one hinge point.

5. The coupling assembly of claim 1, wherein the female coupling further comprises a locking assembly, the locking assembly comprising:
a cam located on an interior of the housing; and
a decoupler mechanically attached to the cam, wherein the decoupler is partially accessible from an exterior of the first portion of the manikin.

6. The coupling assembly of claim 5, wherein the cam comprises a spring-loaded cam.

7. The coupling assembly of claim 5, wherein the coupling interface comprises at least one cam interface.

8. The coupling assembly of claim 1, wherein the mating connection comprises electrically connecting the female coupling assembly and the male coupling assembly.

9. The coupling assembly of claim 8, wherein:
the female coupling assembly comprises a first electrical coupling;
the male coupling assembly comprises a second electrical coupling; and
the mating connection comprises electrically connecting the first electrical coupling and the second electrical coupling.

10. The coupling assembly of claim 1, wherein:
the first portion of the manikin comprises a torso; and
the second portion of the manikin comprises a limb.

11. The coupling assembly of claim 1, wherein:
the first portion of the manikin comprises a first portion of a limb; and
the second portion of the manikin comprises a second portion of a limb.

12. The coupling assembly of claim 1, wherein the second portion of the manikin comprises an artificial injury.

13. The coupling assembly of claim 12, wherein the second hydraulic hose is in fluidic communication with the artificial injury.

14. The coupling assembly of claim 1, wherein the housing comprises a ramp located within an interior of the housing.

15. The coupling assembly of claim 1, wherein:
the housing comprises a protruded attachment point; and
the first hydraulic hose and the first fluid coupling are mechanically attached to the housing using the protruded attachment point.

16. The coupling assembly of claim 15, wherein:
the male coupling assembly comprises a second protruded attachment point; and
the second hydraulic hose and the second fluid coupling are mechanically attached to the male coupling assembly using the protruded attachment point.

17. The coupling assembly of claim 16, wherein:
the protruded attachment point located on a first side of the housing;
the second protruded attachment point is located on a first side of the coupling interface; and
the protruded attachment point is aligned with the second protruded attachment point.

18. The coupling assembly of claim 1, wherein the mating connection comprises a fluidic connection between the first fluid coupling and the second fluid coupling.

19. The coupling assembly of claim 1, wherein:
the clamp is mechanically attached to a first side of the housing;
the female coupling further comprises a locking assembly; and
the locking assembly is mechanically attached to a second side of the housing, wherein the second side of the housing is opposite of the first side of the housing.

20. A coupling assembly for a manikin, the coupling assembly comprising:
a female coupling assembly embedded within a first portion of a manikin, the female coupling assembly comprising:
a housing;
a first hydraulic hose mechanically attached to the housing;
a clamp mechanically attached to the housing, wherein the clamp comprises a protruding arm; and
a first fluid coupling in fluidic communication with the first hydraulic hose; and
a male coupling assembly at least partially embedded within a second portion of the manikin, wherein the second portion of the manikin comprises an artificial injury, the male coupling assembly comprising:
a coupling interface;
a second hydraulic hose mechanically attached to the coupling interface, wherein the second hydraulic hose is in fluidic communication with the artificial injury; and
a second fluid coupling in fluidic communication with the second hydraulic hose to mate with the first fluid coupling; and
a mating connection between the male coupling assembly and the female coupling assembly.
